(19) United States
(12) Patent Application Publication
(10) Pub. No.: US 2016/0377023 A1
(43) Pub. Date: Dec. 29, 2016

(54) CYLINDER BLOCK WATER JACKET STRUCTURE HAVING INSERT

(71) Applicant: HYUNDAI MOTOR COMPANY, Seoul (KR)

(72) Inventors: Ingee SUH, Yongin-si (KR); Wootae KIM, Anyang-si (KR)

(73) Assignee: HYUNDAI MOTOR COMPANY, Seoul (KR)

(21) Appl. No.: 14/945,021

(22) Filed: Nov. 18, 2015

(30) Foreign Application Priority Data
Jun. 29, 2015 (KR) 10-2015-0092459

(51) Int. Cl. F02F 1/14; F02F 11/00; F02F 1/40

(52) U.S. Cl. CPC F02F 1/14; F02F 1/40; F02F 11/002; F01P 2003/021

(57) ABSTRACT

A cylinder block water jacket structure having an insert includes an intake side insert that is inserted into the intake side of a block coolant jacket of a cylinder block. The intake side insert includes: a separation portion that vertically separates the block coolant jacket; a leg that is extended by a predetermined distance to a lower portion in order to support the separation portion with an upper portion; and a flow blocking portion that is extended by a predetermined distance from both end portions to an upper portion of the separation portion to block coolant that is injected into an upper portion of the separation portion from flowing to the exhaust side of the block coolant jacket. Furthermore, a connection passage is formed in the separation portion to have coolant flow from a lower portion to an upper portion of the block coolant jacket.

### CROSS-REFERENCE TO RELATED APPLICATION

This application claims the benefit of Korean Patent Application No. 10-2015-0092459, filed on Jun. 29, 2015, which is incorporated herein by reference by in its entirety.

### FIELD

The present disclosure relates to a cylinder block water jacket structure having an insert improving cooling efficiency.

### BACKGROUND

The statements in this section merely provide background information related to the present disclosure and may not constitute prior art.

An engine generates a torque by combustion of fuel and discharges the remaining energy as thermal energy. Particularly, coolant absorbs thermal energy while circulating an engine, a heater, and a radiator and discharges the thermal energy to the outside.

When a temperature of a coolant of the engine is low, viscosity of oil increases and thus a frictional force increases and fuel consumption may increase, and a temperature of an exhaust gas slowly rises, whereby an activation time of a catalyst may be extended and a quality of an exhaust gas may be deteriorated. Further, as a normalization time of a heater function is extended, an occupant and a driver may be cold.

When a coolant temperature of an engine is excessively high, knocking occurs and in order to suppress knocking, when adjusting ignition timing, a performance thereof may be deteriorated. Further, when a temperature of a lubricant is excessively high, a lubrication operation may be deteriorated.

Therefore, with a method of highly maintaining a coolant temperature of a specific portion of an engine and maintaining to be low a coolant temperature of other portions thereof, one coolant control valve that controls several cooling elements through one valve is applied.

In several cooling elements, a cylinder block and a cylinder head are an important cooling element, and technology that cools such a cylinder block and cylinder head by separating has been researched. Particularly, a research for more efficiently cooling an engine by controlling flow of coolant in a coolant jacket has been together performed.

As the conventional art, there is Korean Patent Publication No. 10-2013-0019172.

The above information disclosed in this Background section is only for enhancement of understanding of the present disclosure and may contain information that is not f already known in this country to a person of ordinary skill in the art.

### SUMMARY

The present disclosure provides a cylinder block water jacket structure having an insert having advantages of being capable of more effectively controlling flow of coolant by enhancing a structure of an insert that is inserted into a block coolant jacket of a cylinder block and enhancing a structure of a gasket and a cylinder coolant jacket corresponding thereto.

An embodiment of the present disclosure provides a cylinder block water jacket structure having an insert including: an intake side insert that is inserted into the intake side of a block coolant jacket of a cylinder block, wherein the intake side insert includes: a separation portion that vertically separates the block coolant jacket and in which a connection passage in which coolant flows from a lower portion to an upper portion of the block coolant jacket is formed; a leg that is extended by a predetermined distance to a lower portion in order to support the separation portion with an upper portion; and a flow blocking portion that is extended by a predetermined distance from both end portions to an upper portion of the separation portion to block coolant that is injected into the upper portion of the separation portion from flowing to the exhaust side of the block coolant jacket.

The cylinder block water jacket structure may further include a coolant pump that pumps coolant to a lower portion of the separation portion of the intake side insert.

The cylinder block water jacket structure may further include: a cylinder head that is disposed in an upper portion of the cylinder block and that has a head coolant jacket therein; and a gasket that is interposed between the cylinder head and the cylinder block, wherein in the gasket, a coolant distribution passage for supplying coolant that is moved from a lower portion of the intake side insert to an upper portion of the intake side insert through the connection passage to the head coolant jacket may be formed at the intake side.

The coolant distribution passage may be arranged at a predetermined gap from the intake side to a length direction of the cylinder block.

At the intake side of the head coolant jacket, a connection jacket that receives distribution of coolant to correspond to the coolant distribution passage may be formed in a lower portion.

Coolant that is supplied to a lower portion of the separation portion may be moved to the exhaust side of the block coolant jacket and be moved to an upper portion through a coolant discharge passage that is formed in one end portion of the gasket.

The cylinder block water jacket structure may further include a coolant control valve that is disposed at the opposite side of the coolant pump in order to independently control coolant that is discharged from the head coolant jacket and coolant that is discharged through the coolant discharge passage.

The coolant control valve may include: a first coolant control valve that controls coolant that is discharged from the head coolant jacket; and a second coolant control valve that controls coolant that is discharged from the block coolant jacket.

The connection jacket may be formed at both sides of the intake side to correspond to each cylinder.

In a lower portion of the exhaust side of the block coolant jacket, an intake side insert that induces block coolant to flow to an upper portion may be disposed.

Another embodiment of the present disclosure provides an insert for a coolant jacket including: a separation portion that is formed at the intake side in order to vertically separate a block coolant jacket and in which a connection passage in which coolant flows from a lower portion to an upper portion of the block coolant jacket is formed; a leg that is extended by a predetermined distance to a lower portion in order to support the separation portion with an upper portion; and a flow blocking portion that is extended by a predetermined distance from both end portions to an upper portion of the separation portion to block coolant that is injected from a lower portion to the upper portion of the separation portion through the connection passage from flowing to the exhaust side of the block coolant jacket.

The leg may be extended to the lower portion of the separation portion and be disposed at a predetermined gap.

The flow blocking portion may be integrally extended from both end portions to the upper portion of the separation portion, and the connection passage may be formed adjacent to one of the flow blocking portions between the flow blocking portions.

The connection passage may be formed between the legs.

The separation portion, the leg, and the flow blocking portion may be integrally formed.

According to the present disclosure, at the intake side of a block coolant jacket, an intake side insert is disposed, and the intake side insert vertically divides the block coolant jacket and coolant can move to an upper portion through a coolant passage of the intake side insert.

Further, coolant that is moved to the upper portion of the intake side insert is distributed to the intake side of a head coolant jacket through a distribution passage of a gasket, and coolant that is distributed to the intake side of the head coolant jacket flows from the intake side to the exhaust side and thus a cylinder head can be effectively cooled.

By controlling each coolant that is discharged from the block coolant jacket and the head coolant jacket, a coolant control valve separates a cylinder head and a cylinder block, thereby controlling each coolant.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of an engine cooling system according to an embodiment of the present disclosure;

FIG. 2 is an exploded perspective view illustrating a coolant jacket that is formed in an engine cooling system having an insert according to an embodiment of the present disclosure;

FIG. 3 is a top plan view illustrating a gasket and an insert that are provided in an engine cooling system according to an embodiment of the present disclosure;

FIG. 4 is a perspective view illustrating an insert according to an embodiment of the present disclosure;

FIG. 5 is a perspective view illustrating a coolant jacket that is formed in an engine cooling system according to an embodiment of the present disclosure; and

FIG. 6 is a cross-sectional view illustrating a coolant jacket that is formed in an engine cooling system according to an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

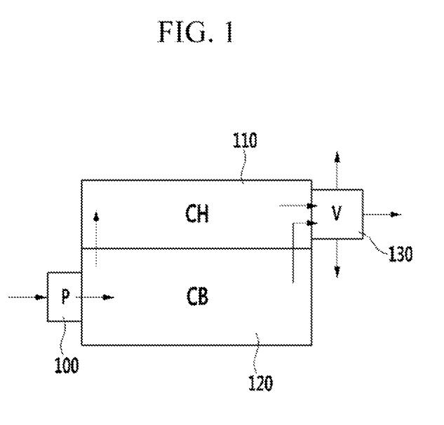

Referring to FIG. 1, the engine cooling system includes a coolant pump 100, a cylinder head 110, a cylinder block 120, and a coolant control valve 130.

At the inside of the cylinder block 120, a cylinder that disposes a piston (not shown) is formed, and at a periphery of the cylinder, a block coolant jacket 210 in which coolant flows is formed.

On the cylinder block 120, the cylinder head 110 is disposed, and at the inside of the cylinder head 110, an exhaust port (not shown) and an intake port (not shown) are formed, and at a periphery thereof, a head coolant jacket 200 is formed.

In one end portion of the cylinder block 120, the coolant pump 100 is disposed, and in the other end portion of the cylinder head 110, the coolant control valve 130 is disposed, the coolant pump 100 pumps coolant through one end portion of the cylinder block 120, and a portion of coolant that is supplied to the cylinder block 120 passes through the cylinder block 120, and the remaining portions thereof move to an upper portion to be supplied to the cylinder head 110.

The coolant control valve 130 independently controls coolant, having passed through the cylinder head 110 and coolant, having passed through the cylinder block 120, thereby improving entire cooling efficiency. Here, the coolant control valve 130 may be disposed in two or may be formed in one for the cylinder head 110 and the cylinder block 120.

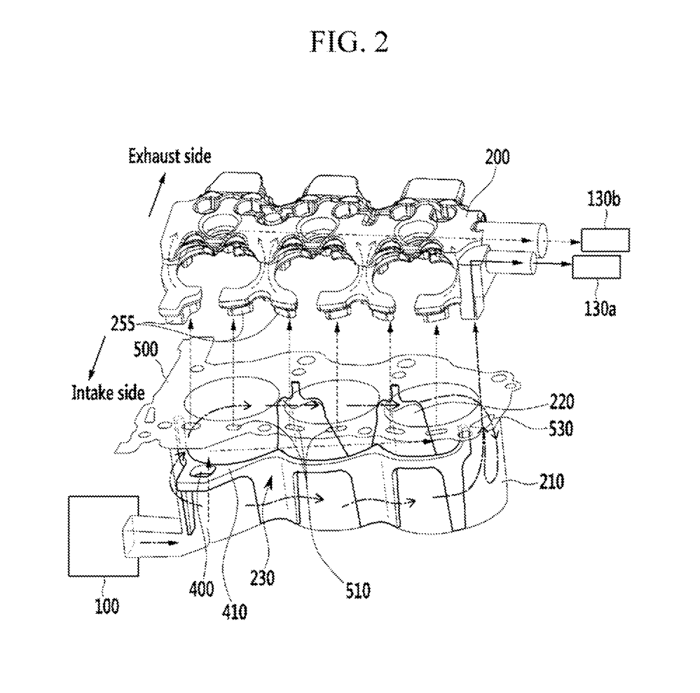

FIG. 2 is an exploded perspective view illustrating a coolant jacket that is formed in an engine cooling system having an insert according to an embodiment of the present disclosure.

Referring to FIG. 2, the engine cooling system includes a coolant pump 100, a connection passage 400, a separation portion 410, an intake side insert 230, a coolant distribution passage 510, a block coolant jacket 210, a coolant discharge passage 530, an exhaust side insert 220, a first coolant control valve 130a, a second coolant control valve 130b, a head coolant jacket 200, a coolant connection jacket 255, and a gasket 500.

In the intake side insert 230, a separation portion 410 that vertically divides the block coolant jacket 210 is formed, and in one end portion of the separation portion 410, a connection passage 400 that vertically connects the block coolant jacket 210 is formed.

The coolant pump 100 pumps coolant to a lower portion of the block coolant jacket 210, i.e., a lower portion of the separation portion 410, and coolant that is supplied to the lower portion of the separation portion 410 circulates the intake side and the exhaust side of the block coolant jacket 210 and moves to an upper portion through the coolant discharge passage 530 that is formed in the gasket 500 and is circulated to the first coolant control valve 130a.

A portion of coolant that is supplied to the lower portion of the separation portion 410 by the coolant pump 100 moves to the upper portion of the separation portion 410 through the connection passage 400, and coolant that is moved to the upper portion is distributed to the coolant connection jacket 255 that is formed in a lower portion of the intake side of the head coolant jacket 200 via the coolant distribution passage 510 of the gasket 500.

Coolant that is distributed to the coolant connection jacket 255 cross flows from the intake side to the exhaust side of the head coolant jacket 200 and is again circulated to the second coolant control valve 130b that is disposed at the other end portion of the head coolant jacket 200.

Coolant that is supplied to the coolant connection jacket 255 cools a cooling element while flowing a periphery of an intake port (not shown), an intake valve, an injector or a plug, an exhaust port, and an exhaust valve of the cylinder head 110.

The exhaust side insert 220 is disposed in a lower portion of the block coolant jacket 210 to induce coolant flowing the block coolant jacket 210 to flow to an upper portion.

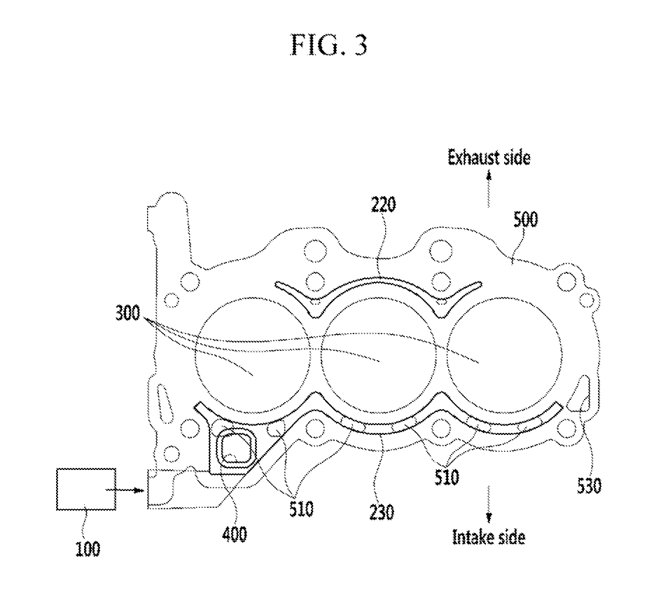

FIG. 3 is a top plan view illustrating a gasket and an insert that are provided in an engine cooling system according to an embodiment of the present disclosure.

Referring to FIG. 3, in the gasket 500, a cylinder hole 300 is formed to correspond to each cylinder, and at the intake side of an engine, two coolant distribution passages 510 are arranged at a predetermined gap to correspond to each cylinder.

The coolant pump 100 pumps coolant to a lower portion of the intake side insert 230 that is provided in the block coolant jacket 210, and the pumped coolant again moves to an upper portion through the connection passage 400 of the intake side insert 230, and the moved coolant is distributed to the coolant connection jacket 255 that is formed at the intake side of each cylinder through the coolant distribution passage 510.

Further, at the side of the coolant distribution passage 510 that is formed in an end portion of the right side, a coolant discharge passage 530 is formed, and coolant flowing the block coolant jacket 210 of the cylinder block 120 is circulated to the first coolant control valve 130a through the coolant discharge passage 530.

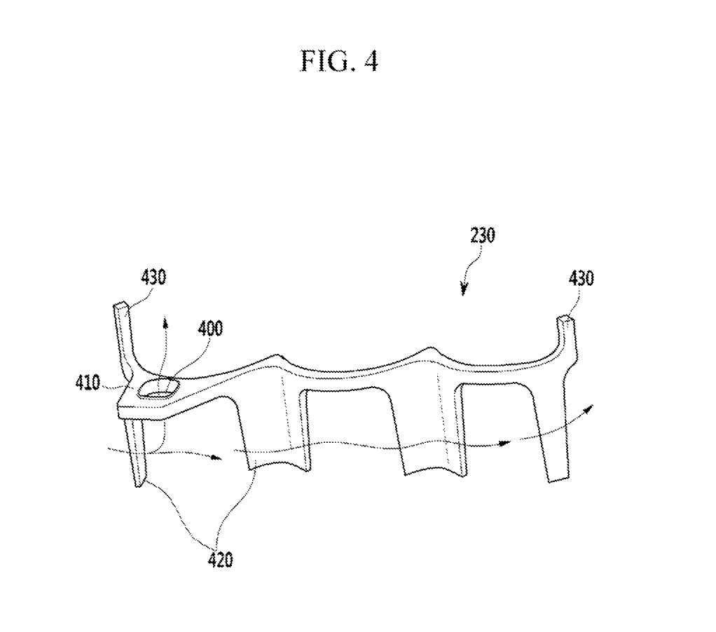

FIG. 4 is a perspective view illustrating an insert according to an embodiment of the present disclosure.

Referring to FIG. 4, the intake side insert 230 includes a separation portion 410, a connection passage 400, a leg 420, and a flow blocking portion 430, and the separation portion 410, the connection passage 400, the leg 420, and the flow blocking portion 430 are integrally formed.

The separation portion 410 performs a function of vertically dividing the block coolant jacket 210, and the leg 420 is extended to a lower portion of the separation portion 410 to lift the separation portion 410 in a predetermined height in the block coolant jacket 210. Here, the leg 420 is arranged at a predetermined gap in a length direction in a lower portion of the separation portion 410.

In both end portions of the separation portion 410, the flow blocking portion 430 is extended to an upper portion, and the flow blocking portion 430 blocks coolant that is supplied to an upper portion of the separation portion 410 from flowing to the exhaust side of the block coolant jacket 210 and enables coolant that is supplied to the upper portion of the separation portion 410 to be supplied to the coolant connection jacket 255 of the head coolant jacket 200.

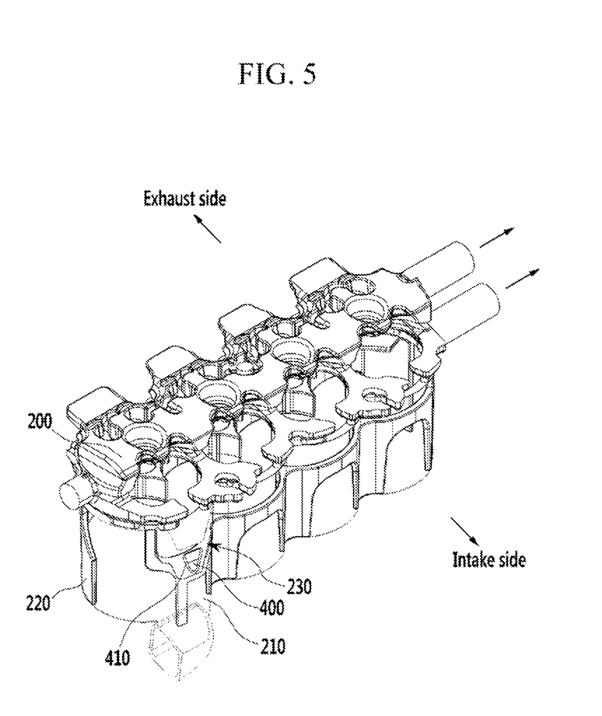

FIG. 5 is a perspective view illustrating a coolant jacket that is formed in an engine cooling system according to an embodiment of the present disclosure, FIGS. 2, 3, and 4 illustrate that the intake side insert 230 is applied to a 3-cylindered engine, and FIG. 5 illustrates that the intake side insert 230 is applied to a 4-cylindered engine.

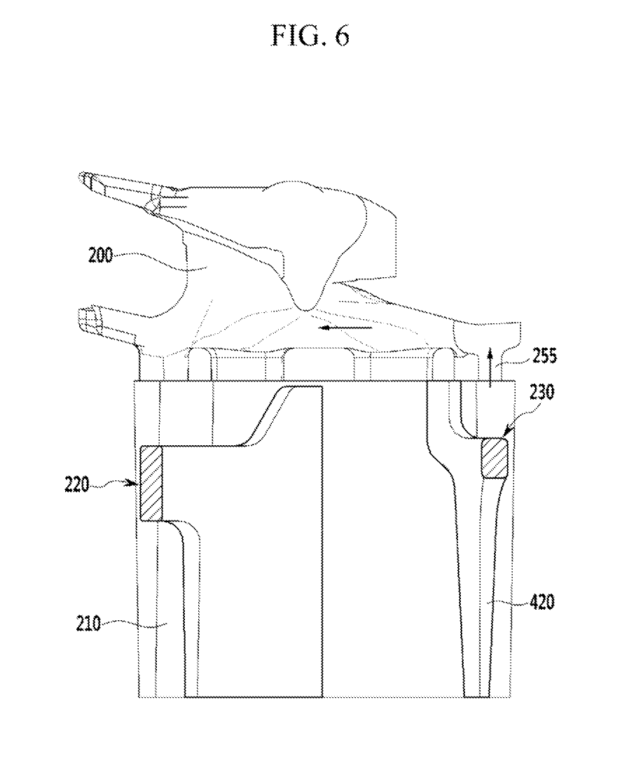

FIG. 6 is a cross-sectional view illustrating a coolant jacket that is formed in an engine cooling system according to an embodiment of the present disclosure.

Referring to FIG. 6, at the intake side of the block coolant jacket 210, the intake side insert 230 is disposed, and at the exhaust side thereof, the exhaust side insert 220 is disposed.

Further, in a lower portion of the intake side of the head coolant jacket 200, the coolant connection jacket 255 is extended to a lower portion, and the coolant connection jacket 255 is connected to the block coolant jacket 210 through the coolant distribution passage 510 of the gasket 500.

Coolant that is supplied from an upper portion of the block coolant jacket 210 through the coolant connection jacket 255 flows from the intake side to the exhaust side, flows again in a length direction of the cylinder head 110 and is thus circulated to the second coolant control valve 130b.

While this present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: coolant pump | 110: cylinder head |
| 120: cylinder block | 130a: first coolant control valve |
| 130b: second coolant control valve | 130: coolant control valve |
| 200: head coolant jacket | 210: block coolant jacket |
| 220: exhaust side insert | 230: intake side insert |
| 255: coolant connection jacket | 300: cylinder hole |
| 400: connection passage | 410: separation portion |
| 420: leg | 430: flow blocking portion |
| 500: gasket | 510: coolant distribution passage |
| 530: coolant discharge passage | |

What is claimed is:

1. A cylinder block water jacket structure having an insert, comprising:
an intake side insert that is inserted into an intake side of a block coolant jacket of a cylinder block,
wherein the intake side insert comprises:
a separation portion configured to vertically separate the block coolant jacket, a connection passage being formed in a portion of the separation portion, and a coolant in the connection passage flowing from a lower portion to an upper portion of the block coolant jacket;
a leg extended by a predetermined distance to a lower portion of the separation so as to support the separation portion; and
a flow blocking portion extended by a predetermined distance from both end portions to an upper portion of the separation portion to block a coolant that is injected into the upper portion of the separation portion from flowing to an exhaust side of the block coolant jacket.

2. The cylinder block water jacket structure of claim 1, further comprising a coolant pump configured to pump the coolant to the lower portion of the separation portion of the intake side insert.

3. The cylinder block water jacket structure of claim 2, further comprising:
a cylinder head that is disposed in an upper portion of the cylinder block and that has a head coolant jacket therein; and
a gasket that is interposed between the cylinder head and the cylinder block,
wherein in the gasket, a coolant distribution passage for supplying a coolant that is moved from a lower portion of the intake side insert to an upper portion of the intake side insert through the connection passage to a head coolant jacket is formed at the intake side.

4. The cylinder block water jacket structure of claim 3, wherein the coolant distribution passage is arranged at a predetermined gap from the intake side to a length direction of the cylinder block.

5. The cylinder block water jacket structure of claim 4, wherein at an intake side of the head coolant jacket, a connection jacket configured to receive distribution of a coolant to correspond to the coolant distribution passage is formed in a lower portion.

6. The cylinder block water jacket structure of claim 5, wherein the connection jacket is formed at both sides of the intake side to correspond to each cylinder.

7. The cylinder block water jacket structure of claim 5, wherein in a lower portion of the exhaust side of the block coolant jacket, an intake side insert configured to induce a block coolant to flow to an upper portion is disposed.

8. The cylinder block water jacket structure of claim 2, wherein the coolant that is supplied to the lower portion of the separation portion moves to the exhaust side of the block coolant jacket and moves to an upper portion through a coolant discharge passage that is formed in one end portion of a gasket.

9. The cylinder block water jacket structure of claim 8, further comprising a coolant control valve that is disposed at an opposite side of the coolant pump configured to independently control a coolant that is discharged from a head coolant jacket and a coolant that is discharged through the coolant discharge passage.

10. The cylinder block water jacket structure of claim 9, wherein the coolant control valve comprises:
a first coolant control valve configured to control the coolant that is discharged from the head coolant jacket; and
a second coolant control valve configured to control the coolant that is discharged from the block coolant jacket.

11. An insert for a coolant jacket, comprising:
a separation portion formed at an intake side of a cylinder block and configured to vertically separate a block coolant jacket, and in the separation portion, a connection passage being formed in which a coolant flows from a lower portion to an upper portion of the block coolant jacket;
legs that are extended by a predetermined distance to a lower portion of the separation, the leg configured to support the separation portion with an upper portion thereof; and
flow blocking portions that are extended by a predetermined distance from both end portions to the upper portion of the separation portion to block a coolant that is injected from the lower portion to the upper portion of the separation portion through the connection passage from flowing to an exhaust side of the block coolant jacket.

12. The insert of claim 11, wherein the legs are extended to a lower portion of the separation portion and is disposed at a predetermined gap.

13. The insert of claim 11, wherein the flow blocking portions are integrally extended from both end portions to the upper portion of the separation portion, and the connection passage is formed adjacent to one of the flow blocking portions between the flow blocking portions.

14. The insert of claim 11, wherein the connection passage is formed between the legs.

15. The insert of claim 11, wherein the separation portion, the legs, and the flow blocking portions are integrally formed.
